(19) United States
(12) Patent Application Publication
(10) Pub. No.: US 2014/0130381 A1
(43) Pub. Date: May 15, 2014

(54) FOOTWEAR ABLE TO BE WIRELESSLY CHARGED AND WIRELESS CHARGING DEVICE USED FOR THE SAME

(71) Applicant: Hanrim Postech Co., Ltd., Suwon-si (KR)

(72) Inventor: Chun-Kil JUNG, Seoul (KR)

(73) Assignee: Hanrim Postech Co., Ltd., Suwon-si (KR)

(21) Appl. No.: 14/074,489

(22) Filed: Nov. 7, 2013

(30) Foreign Application Priority Data
Nov. 9, 2012 (KR) 10-2012-0126924

(51) Int. Cl. A43B 7/00; H02J 7/02

(52) U.S. Cl. CPC A43B 7/00; H02J 7/025
USPC 36/136; 320/108

(57) ABSTRACT

Disclosed herein are a footwear able to be wirelessly charged, the footwear including: an insole; an outer cover installed on the insole and having a wear space formed therein; a heel attached to a lower surface of the insole; an ion generator installed in the wear space to create an ionization effect; a battery supplying a power to the ion generator; a secondary coil receiving a wireless power signal from an external wireless charging device; a rectifying module configured to rectify an induced electromotive force generated from the secondary coil; and a controller configured to charge the battery by receiving a power from the rectifying module, and to control an operation of the ion generator, and a wireless charging device used for the same.

### CROSS-REFERENCE TO RELATED APPLICATIONS

This application claims the benefit of Korean Application No. 10-2012-0126924, filed Nov. 9, 2012, in the Korean Intellectual Property Office. All disclosures of the document named above are incorporated herein by reference.

### BACKGROUND OF THE INVENTION

1. Field of the Invention

The present invention relates to a footwear able to be wirelessly charged, capable of providing a clean wear environment through foot odor removal and sterilization without replacing a battery, and a wireless charging device used for the same.

2. Description of the Related Art

Generally, a footwear, which is a kind of body protecting means protecting a foot of a walker, always contacts the ground in the state in which it is worn on the foot of a user. Therefore, the footwear absorbs a sweat secreted from the foot, and is further exposed to an external pollutant that is easily absorbed, such that an inner portion of the footwear becomes damp. Further, in the inner portion of the footwear, due to an interaction of the sweat and the pollutant as described above, various germs may be propagated, odor may be generated, and a disease may result in the user's body.

In order to solve these problems, in the footwear according to the related art, general methods have been suggested such as using a footwear insert having an excellent ventilation property, or boring a ventilation hole in an outer cover of the footwear.

In addition, according to the related art, air may be injected into and ventilated within the footwear to dilute the odor, thereby slightly solving the problems. However, in this scheme, an effect is small and the problems may not be fundamentally solved.

In other solutions, an electronic component is mounted in the footwear in order to implement a sanitary function. However, a continuous power supply is required. Since it is difficult to supply the power from an outer portion of the footwear due to characteristics of the footwear, a battery should be mounted in the footwear.

Generally, since the battery has a limited use time, it should be periodically replaced, which is inconvenient in view of maintenance and causes a cost increase. In addition, there is a risk that moisture will permeate from the outer portion of the footwear through a battery access portion.

### SUMMARY OF THE INVENTION

An object of the present invention is to provide a footwear able to be wirelessly charged, capable of removing odor in the footwear and performing sterilization, and being semi-permanently used without replacing a battery, and a wireless charging device used for the same.

According to an embodiment of the present invention, there is provided a footwear able to be wirelessly charged, the footwear including: an insole; an outer cover installed on the insole and having a wear space formed therein; a heel attached to a lower surface of the insole; an ion generator installed in the wear space to a create an ionization effect; a battery installed in any one of the insole, the outer cover, and the heel, and supplying a power to the ion generator; a secondary coil installed in any one of the insole, the outer cover, and the heel, and receiving a wireless power signal from an external wireless charging device; a rectifying module configured to rectify an induced electromotive force generated from the secondary coil; and a controller configured to charge the battery by receiving a power from the rectifying module, and to control an operation of the ion generator.

The battery, the secondary coil, the rectifying module and the controller may be installed in the heel, and the heel may further include a shielding plate configured to prevent a magnetic field of the secondary coil from being leaked to the rectifying module or the controller.

The heel and the insole may be attached to each other in a waterproof manner.

The footwear may further include a wear detecting sensor installed in any one of the insole and the outer cover and configured to detect whether a user wears the footwear, wherein the controller is configured to control the ion generator based on a signal from the wear detecting sensor.

The wear detecting sensor may be a pressure sensor installed at a portion of an upper surface of the insole, the portion corresponding to the heel, and the controller may include a timer to operate the ion generator for a predetermined period.

The secondary coil may be installed in the heel in a direction vertical or horizontal to the bottom surface of the heel.

The secondary coil may include a first sub coil, and a second sub coil installed on the first sub coil so as to overlap the first sub coil.

The footwear may further include: a biological information detecting sensor installed in the wear space and configured to detect a biological information of a user; a memory installed in any one of the insole, the outer cover, and the heel to store the biological information detected by the biological information detecting sensor; and a communication module configured to transmit the biological information stored in the memory to an external electronic device.

According to another embodiment of the present invention, there is provided a wireless charging device for transmitting a wireless power signal to the footwear as described above, the wireless charging device including: a base upon which the footwear may be placed; and a charging unit installed on or within the base and comprising a primary coil installed in a position corresponding to that of the secondary coil of the footwear.

According to still another embodiment of the present invention, there is provided a wireless charging device for transmitting a wireless power signal to the footwear as described above, the wireless charging device including: a base provided with a recess into which the heel of the footwear may be inserted; and a charging unit installed at or within the recess and comprising a primary coil installed in a position corresponding to that of the secondary coil of the footwear.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side view of a footwear able to be wirelessly charged according to an embodiment of the present invention;

FIG. 2 is a cross-sectional view of the footwear of FIG. 1;

FIG. 3 is a cross-sectional view of a specific kind of footwear able to be wirelessly charged, namely a woman's high heel, according to an embodiment of the present invention;

FIG. 4 is a side view of an example of a wireless charging device for transmitting a wireless power signal to the footwear able to be wirelessly charged according to an embodiment of the present invention;

FIG. 5 is a side view of another example of a wireless charging device for transmitting a wireless power signal to the footwear able to be wirelessly charged according to an embodiment of the present invention; and

FIG. 6 is a block diagram of an electronic configuration of the footwear able to be wirelessly charged according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

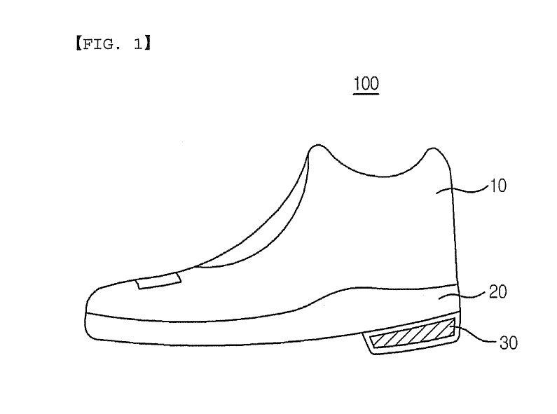

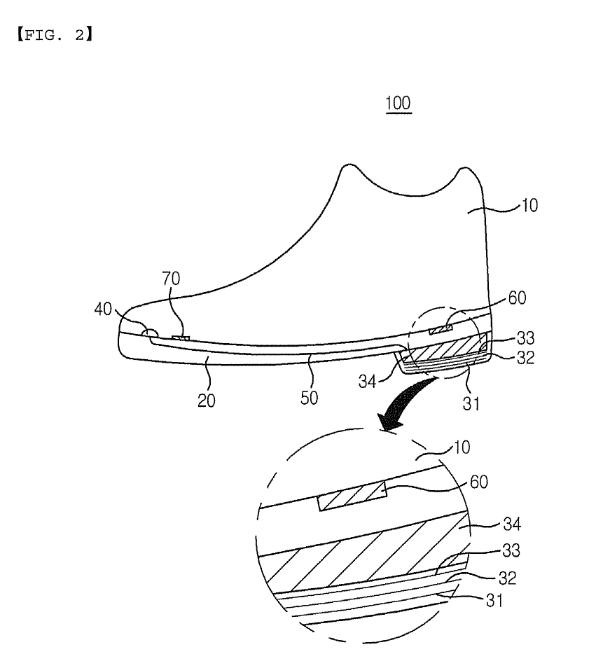

FIG. 1 is a side view of a footwear able to be wirelessly charged according to an embodiment of the present invention; and FIG. 2 is a cross-sectional view of the footwear shown in FIG. 1. As shown in FIGS. 1 and 2, the footwear 100 includes an insole 20, an outer cover 10 formed on the insole 20 and having a wear space formed therein, and a heel 30 attached to a rear part of the insole 20. As shown in FIG. 2, an ion generator 40 for removing odor is attached to the insole 20. Although the ion generator 40 has been installed in the insole in FIG. 2, the present invention is not limited thereto. That is, it is to be understood that the ion generator 40 may be installed in any receiving space formed by the outer cover 10 and the insole 20.

A wireless power receiving device is installed in the heel, and may comprise a secondary coil 31, configured to receive a power signal from a wireless charging device to be described below, and a rectifying module (not shown) configured to rectify an induced electromotive force generated from the secondary coil 31.

In addition, the heel 30 may further comprise a battery 34 charged with a power from the secondary coil 31, a board 33 on which a controller configured to control the wireless power receiving device, the battery 34, and the ion generator 40 is installed, and a shielding plate 32 installed on the secondary coil 31 to prevent a leaked magnetic field from affecting the board 33 or the battery 34.

Here, the secondary coil 31 may include a first sub coil, and a second sub coil installed on the first sub coil so as to overlap or be overlapped with the first sub coil in a longitudinal direction, in order to increase a transmission efficiency. That is, in a case in which a cross-sectional width of the heel is narrow, such that it is difficult to arrange the secondary coil 31 such that it has a sufficient size, two coils are installed to overlap each other, thereby making it possible to increase a reception efficiency of the wireless power signal.

In addition, a pressure sensor 60 may be attached to a portion corresponding to the heel to control an activation and deactivation of the ion generator 40. That is, through the pressure sensor 60, an operation of the ion generator 40 may stop when it is judged that a user is wearing the footwear and start when it is judged that the user is not wearing the footwear. Alternatively, the controller may operate the ion generator 40 for a predetermined period based on a signal from the pressure sensor 60.

Although the pressure sensor 60 has been described as the detecting sensor detecting whether or not the user wears the footwear, the present invention is not limited thereto. That is, it is to be understood that various kinds or numbers of detecting sensors may be installed in the outer cover or the insole to detect whether or not the user wears the footwear.

Meanwhile, a flexible circuit board 50 may be used in order to connect the board 33 and the ion generator 40 to each other. When a person walks or runs, the insole 20 of the footwear 100 is bent. In this case, when the flexible circuit board 50 is used as an electrical connection means between the ion generator 50 and the board 33, even though the insole 20 is bent, durability is not affected at all.

Although an example in which the battery, the board, and the wireless power receiving device are installed in the heel has been described, the present invention is not limited thereto. That is, it is to be understood that the battery, the board, and the wireless power receiving device may also be installed in the insole or the outer cover, among other possible placements.

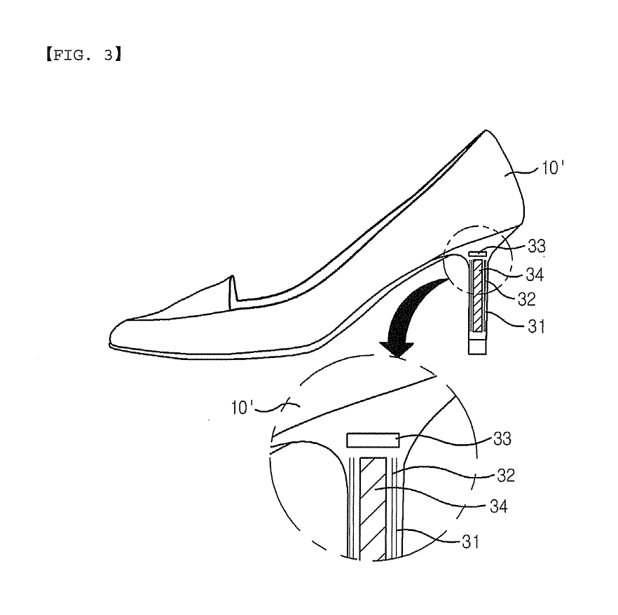

FIG. 3 is a cross-sectional view of a woman's high heel, which is a specific kind of footwear, configured to be wirelessly charged according to an embodiment of the present invention. For simplification reasons, a description of the components already described with reference to FIGS. 1 and 2 will not be duplicated here.

In the case of the woman's high heel, although a size of a horizontal cross section is small, a size of a vertical cross section is large. In consideration of this feature, as shown in FIG. 3, the secondary coil 31 is vertically installed at a side of the heel 30 of the woman's high heel. The secondary coil 31 is installed as described above, thereby making it possible to increase a wireless power transmission efficiency.

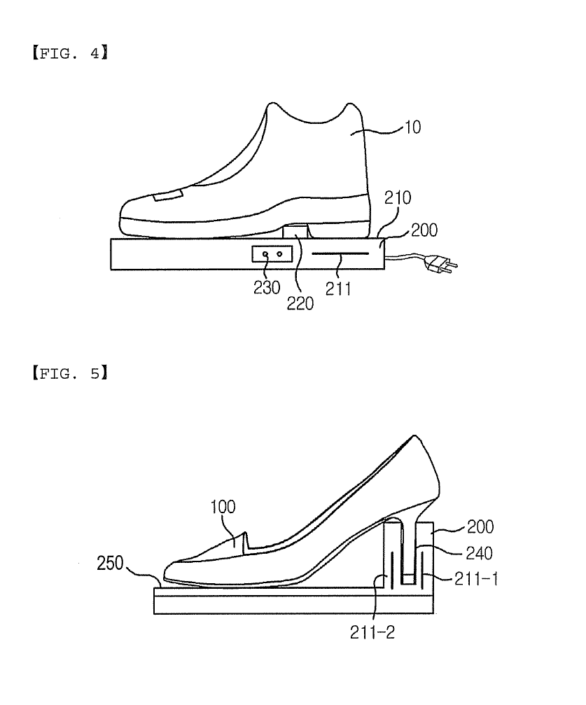

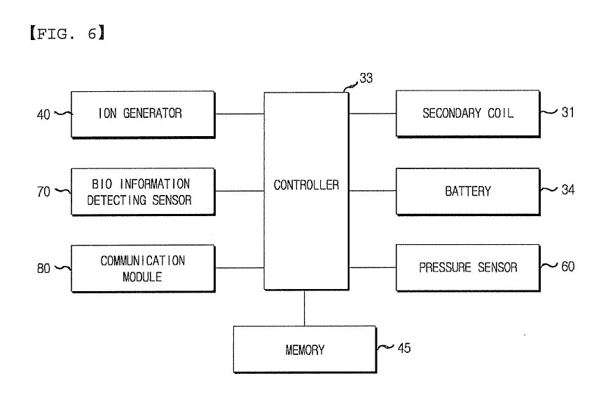

Hereinafter, a wireless charging device for charging the footwear having the above-mentioned configuration will be described with reference to FIGS. 4 and 5.

FIG. 4 is a side view showing an example of a wireless charging device for transmitting a wireless power signal to the footwear according to an embodiment of the present invention. That is, as shown in FIG. 4, in the wireless charging device transmitting a wireless power signal to the footwear, a portion of a main surface of a base 200 forms a charging unit 210 and a primary coil 211 is formed under the charging unit 210. In addition, a catching jaw 220 vertically protrudes from one side of the base 200 so that the heel 30 may be caught, such that the footwear may be placed or stored so as to have a predetermined gradient. Using the above-mentioned configuration, since the primary coil 211 and the secondary coil 31 are closely adhered to each other even in the inclined state, a more optimal wireless charging efficiency may be secured.

FIG. 5 is a side view showing another example of a wireless charging device for transmitting a wireless power signal to the footwear according to an embodiment of the present invention. As shown in FIG. 5, in the case in which the woman's high heel of FIG. 3 is to be charged, since the secondary coil 31, which receives the charge, is installed at the side of the heel, a main surface of the base 200 is provided with a recess 240, the recess 240 is provided with the primary coil, and a support surface 250 capable of supporting a front portion of the footwear is provided. Through the above-mentioned configuration, the secondary coil 31 and the primary coil 211 (two portions of which are depicted as 211-1 and 211-2) are maintained to be closely adhered to each other, thereby making it possible to maintain a more optimal wireless charging efficiency.

FIG. 6 is a block diagram describing an electronic configuration of the footwear according to an embodiment of the present invention. As shown in FIG. 6, the footwear 100 may be configured to include the secondary coil 31, the battery 34, the pressure sensor 60, the ion generator 40, a memory 45, a biological information detecting sensor 70, a communication module 80, and a controller 33. For simplification reasons, previous paragraphs already describing operations of these components will not be duplicated here.

As shown in FIG. 6, according to an embodiment of the present invention, the footwear 100 may further include a biological information detecting sensor 70, which is configured to obtain a pulse information, a body temperature information, or the like. The biological information detecting sensor 70 is installed in the receiving space of the footwear to obtain a biological information of the user, and the biological information obtained as described above is stored in the memory 45. The controller 33 transmits the biological information stored in the memory 45 to an external electronic device, such as a mobile communication terminal of the user, a preset hospital server, or the like, via the communication module 80. The external electronic device obtaining the biological information transmitted as described above checks a health state of the user by using the biological information and, when it is judged that the health state is not good, informs the user of the health state by using a pre-stored email information or cellular phone information.

According to an embodiment of the present invention having the above-mentioned configuration, since the battery is charged using a wireless charging scheme, a waterproof function is provided at a low cost, thereby making it possible to increase durability.

In addition, when the footwear is stored, it may immediately start to be conveniently charged and an inner portion of the footwear may be sterilized by the ion generator, thereby making it possible to always provide a dry and soft feeling to the user.

According to an embodiment of the present invention having the above-mentioned configuration, the ion generator is installed in the wear space of the footwear, such that odor of the wear space is removed and sterilization is performed, thereby making it possible to always provide a clean wear environment to the user.

In addition, since the battery installed in the footwear may be charged in a wireless charging scheme, inconvenience due to replacement of the battery may be solved and a maintenance cost may be decreased.

Meanwhile, since the battery does not need to be replaced, it may be installed in the footwear in a completely closed scheme. As a result, the footwear may be easily manufactured and a problem due to water leakage may be prevented.

Although a few embodiments of the present invention have been shown and described, it would be appreciated by those skilled in the art that changes may be made in this embodiment without departing from the principles and spirit of the invention, the scope of which is defined in the claims and their equivalents. In particular, all or some of the respective exemplary embodiments may be selectively combined with each other so that they may be variously modified.

What is claimed is:

1. A footwear comprising:
an insole;
an outer cover installed on the insole and having a wear space formed therein;
a heel attached to a lower surface of the insole;
an ion generator installed in the wear space to create an ionization effect;
a battery installed in any one of the insole, the outer cover, and the heel, and supplying a power to the ion generator;
a secondary coil installed in any one of the insole, the outer cover, and the heel, and receiving a wireless power signal from an external wireless charging device;
a rectifying module configured to rectify an induced electromotive force generated from the secondary coil; and
a controller configured to control an operation of the ion generator.

2. The footwear of claim 1, wherein the battery, the secondary coil, the rectifying module, and the controller are installed in the heel, and
the heel further comprises a shielding plate configured to prevent a magnetic field of the secondary coil from being leaked to the rectifying module or the controller.

3. The footwear of claim 1, wherein the heel and the insole are attached to each other in a waterproof manner.

4. The footwear of the claim 1, further comprising a wear detecting sensor installed in any one of the insole and the outer cover and configured to detect whether a user wears the footwear,
wherein the controller is configured to control the ion generator based on a signal from the wear detecting sensor.

5. The footwear of claim 4, wherein the wear detecting sensor comprises a pressure sensor installed at a portion of an upper surface of the insole, the portion corresponding to the heel, and
the controller includes a timer to operate the ion generator for a predetermined period.

6. The footwear of claim 1, wherein the secondary coil is installed in the heel in a direction vertical or horizontal to the bottom surface of the heel.

7. The footwear of claim 1, wherein the secondary coil comprises a first sub coil, and a second sub coil installed on the first sub coil so as to overlap the first sub coil.

8. The footwear of claim 1, further comprising:
a biological information detecting sensor installed in the wear space and configured to detect a biological information of a user;
a memory installed in any one of the insole, the outer cover, and the heel to store the biological information detected by the biological information detecting sensor; and
a communication module configured to transmit the biological information stored in the memory to an external electronic device.

9. A wireless charging device for transmitting a wireless power signal to the footwear of claim 1, the wireless charging device comprising:
a base upon which the footwear may be placed; and
a charging unit installed on or within the base and comprising a primary coil installed in a position corresponding to that of the secondary coil of the footwear.

10. A wireless charging device for transmitting a wireless power signal to the footwear of claim 2, the wireless charging device comprising:
a base provided with a recess into which the heel of the footwear may be inserted; and
a charging unit installed at or within the recess and comprising a primary coil installed in a position corresponding to that of the secondary coil of the footwear.

11. The footwear of claim 1, wherein the controller is further configured to charge the battery by receiving a power from the rectifying module.
